(19) United States
(12) Patent Application Publication
(10) Pub. No.: US 2025/0217936 A1
(43) Pub. Date: Jul. 3, 2025

(54) METHOD AND DEVICE FOR GENERATING BUILDING SYNTHETIC IMAGE BASED ON ARTIFICIAL INTELLIGENCE USING SATELLITE IMAGE

(71) Applicant: VISOL INC., Gwangmyeong-si (KR)

(72) Inventors: Hyung Oh PARK, Incheon (KR); Myung Ho SEO, Gwangmyeong-si (KR); Tae Won SEO, Bucheon-si (KR)

(73) Assignee: VISOL INC., Gwangmyeong-si (KR)

(21) Appl. No.: 18/955,662

(22) Filed: Nov. 21, 2024

(30) Foreign Application Priority Data
Dec. 29, 2023 (KR) 10-2023-0196227

(51) Int. Cl. G06T 5/60; G06T 5/80

(52) U.S. Cl. CPC G06T 5/60; G06T 5/80; G06T 2207/10032; G06T 2207/20084

(57) ABSTRACT

Disclosed is a method of generating a synthetic image based on artificial intelligence using a satellite image, which is performed by a processor. The method of generating a synthetic image based on artificial intelligence using a satellite image includes applying a satellite image captured by a satellite to a neural network to infer a boundary of an upper surface and a boundary of a side surface of a building included in the satellite image, and generating a new building based on the inferred boundary of the upper surface and the inferred boundary of the side surface of the building and synthesizing the new building into the satellite image.

### CROSS-REFERENCE TO RELATED APPLICATION

This application claims priority to and the benefit of Korean Patent Application No. 2023-0196227, filed on Dec. 29, 2023, the disclosure of which is incorporated herein by reference in its entirety.

### BACKGROUND

### 1. Field of the Invention

The present invention relates to the generation of a synthetic image, and more particularly, to a method and device for generating a building synthetic image based on artificial intelligence using a satellite image.

### 2. Discussion of Related Art

In order to simulate in advance what a specific structures or building will look like in a satellite image captured by an artificial satellite when constructed in an undeveloped bare land in the future, there may be a need to generate a synthetic image in which a satellite image and an artificial structure are synthesized. In addition, in order to simulate a structure, a building, or the like that is present in an area that is not revealed for security reasons in a satellite image captured by an artificial satellite, there may be a need to generate a synthetic image in which a satellite image and an artificial structure are synthesized.

### Related Art Documents

### PATENT DOCUMENTS

(Patent Document 1) Korean Patent Registration No. 10-2441675 (Sep. 5, 2022)

### SUMMARY OF THE INVENTION

The present invention is directed to providing a method and device for generating a building synthetic image based on artificial intelligence using a satellite image, in which a new building may be generated and synthesized in consideration of an existing building included in a satellite image.

According to an aspect of the present invention, there is provided a method of generating a synthetic image based on artificial intelligence using a satellite image, which is performed by a processor, the method includes applying a satellite image captured by a satellite to a neural network to infer a boundary of an upper surface and a boundary of a side surface of a building included in the satellite image, and generating a new building based on the inferred boundary of the upper surface and the inferred boundary of the side surface of the building and synthesizing the new building into the satellite image.

The method may further include generating an inferred position relationship between the upper surface and the side surface of the building based on the inferred boundary of the upper surface and the inferred boundary of the side surface of the building.

The method may further include receiving information about center coordinates of the new building, at which the new building is to be positioned in the satellite image, and information about a width and a height of the new building from a user to generate the new building.

The method may further include receiving information about center coordinates of the new building, at which the new building is to be positioned in the satellite image, and information about an area of an upper surface of the new building from a user to generate the new building, determining whether the received area of the upper surface of the new building corresponds to an area between a maximum and a minimum area among areas of upper surfaces of buildings included in the satellite image, and requesting the user for information about the area of the upper surface of the new building when it is determined that the received area of the upper surface of the new building does not correspond to the area between the maximum area and the minimum area among the areas of the upper surfaces of the buildings included in the satellite image.

The method may further include rotating the new building synthesized into the satellite image according to an inclination of the inferred boundary of the upper surface of the building.

According to another aspect of the present invention, there is provided a device including a processor configured to execute instructions for generating a synthetic image based on artificial intelligence using a satellite image, and a memory configured to store the instructions.

The instructions may be implemented to apply a satellite image captured by a satellite to a neural network to infer a boundary of an upper surface and a boundary of a side surface of a building included in the satellite image and generate a new building based on the inferred boundary of the upper surface and the inferred boundary of the side surface of the building to synthetize the new building into the satellite image.

The instructions may be further implemented to generate an inferred position relationship between the upper surface and the side surface of the building based on the inferred boundary of the upper surface and the inferred boundary of the side surface of the building.

The instructions may be further implemented to receive information about center coordinates of the new building, at which the new building is to be positioned in the satellite image, and information about a width and a height of the new building from a user to generate the new building.

The instructions may be further implemented to receive information about center coordinates of the new building, at which the new building is to be positioned in the satellite image, and information about an area of an upper surface of the new building from a user to generate the new building, determine whether the received area of the upper surface of the new building corresponds to an area between a maximum and a minimum area among areas of upper surfaces of buildings included in the satellite image, and request the user for information about the area of the upper surface of the new building when it is determined that the received area of the upper surface of the new building does not correspond to the area between the maximum area and the minimum area among the areas of the upper surfaces of the buildings included in the satellite image.

The instructions may be further implemented to rotate the new building synthesized into the satellite image according to an inclination of the inferred boundary of the upper surface of the building.

### BRIEF DESCRIPTION OF THE DRAWINGS

A detailed description of each drawing is provided to facilitate a more thorough understanding of the drawings referenced in the detailed description of the present invention:

FIG. 1 is a block diagram of a device for generating a synthetic image based on artificial intelligence using a satellite image according to an embodiment of the present invention;

FIGS. 2A to 2C show conceptual views for describing an operation of applying a satellite image to a neural network to infer a boundary of an upper surface and a boundary of a side surface of a building included in the satellite image;

FIGS. 3A to 3D shows images for describing various position relationships between an upper surface and a side surface of a building;

FIGS. 4A to 4B and 5A to 5B show satellite images for describing an operation of synthesizing a new building into a satellite image according to an embodiment of the present invention;

FIGS. 6A to 6B shows satellite images for describing an operation of synthesizing a new building into a satellite image;

FIG. 7 is a flowchart for describing a method of generating a synthetic image based on artificial intelligence using a satellite image according to an embodiment of the present invention; and

FIGS. 8A to 8C shows images for describing the method of generating a synthetic image based on artificial intelligence using a satellite image according to the embodiment of the present invention.

### DETAILED DESCRIPTION OF EXEMPLARY EMBODIMENTS

The specific structural or functional descriptions according to the embodiments of the concepts of the present invention disclosed in this specification are only examples for illustrating the embodiments of the concept of the present invention, and various embodiments according to the concept of the present invention can be implemented in various form and are not limited to the embodiments described herein.

Since the embodiments according to the concept of the present invention can be subject to various changes and have various forms, specific embodiments are illustrated in the drawings and described in detail herein. However, it should be understood that this is not intended to limit the embodiments according to the concept of the present invention to specific embodiments, and includes all transformations, equivalents, or substitutes included in the spirit and scope of the present invention.

Although the terms first, second, or the like may be used herein to describe various components, these components should not be limited by these terms. These terms are only used to distinguish one component from another component. For example, a first component may be referred to as a second component, and similarly, a second component may be referred to as a first component without departing from the scope of the present invention.

When a certain component is mentioned as being “connected” or “linked” to another component, it should be understood that the certain component may be directly connected or linked to another component, but still another component may be present therebetween. On the other hand, when it is mentioned that a certain component is “directly connected” or “directly linked” to another element, it should be understood that there is no other certain component therebetween. The same principle applies to other expressions, such as “between ^{˜}” and “just between ^{˜}” or “adjacent to ^{˜}” and “adjacent just to ^{˜},” which describe a relationship between components.

The terms used in this specification are merely used to describe specific embodiments and are not intended to limit the present invention. An expression of a singular number includes an expression of the plural number, so long as it is clearly read differently. In the present specification, the word “comprise” or “has” is used to specify existence of a feature, a numbers, a process, an operation, a constituent element, a part, or a combination thereof, and it will be understood that existence or additional possibility of one or more other features or numbers, processes, operations, constituent elements, parts, or combinations thereof are not excluded in advance.

Unless defined otherwise, all the terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention is described by describing exemplary embodiments of the present invention in detail with reference to the accompanying drawings.

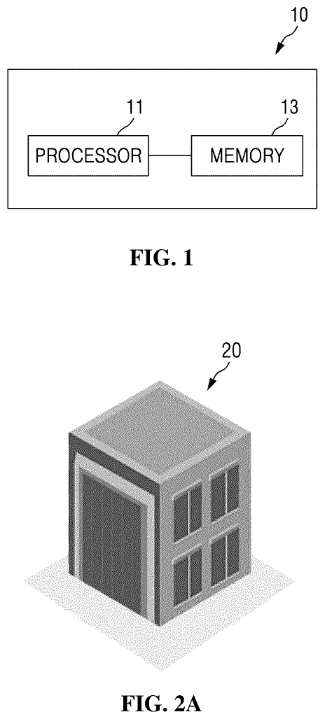

FIG. 1 is a block diagram of a device for generating a synthetic image based on artificial intelligence using a satellite image according to an embodiment of the present invention.

Referring to FIG. 1, a device 10 is an electronic device capable of executing a method of generating a synthetic image based on artificial intelligence using a satellite image. The device 10 is an electronic device such as a server, a desktop computer, a laptop computer, a smartphone, or a tablet personal computer (PC). The device 10 may be referred to as a computing device.

The device 10 includes a processor 11 capable of executing instructions for generating a synthetic image based on artificial intelligence using a satellite image and a memory 13 for storing the instructions.

A satellite image is generated by an artificial satellite, and a synthetic image is a video or an image generated by artificially generating a new building and synthesizing the generated new building to a satellite image. The satellite image may be one video frame, that is, an image.

A new building is a building that is not present in a satellite image captured by an artificial satellite and is a building that is artificially generated by a program or instructions executed by the device 10.

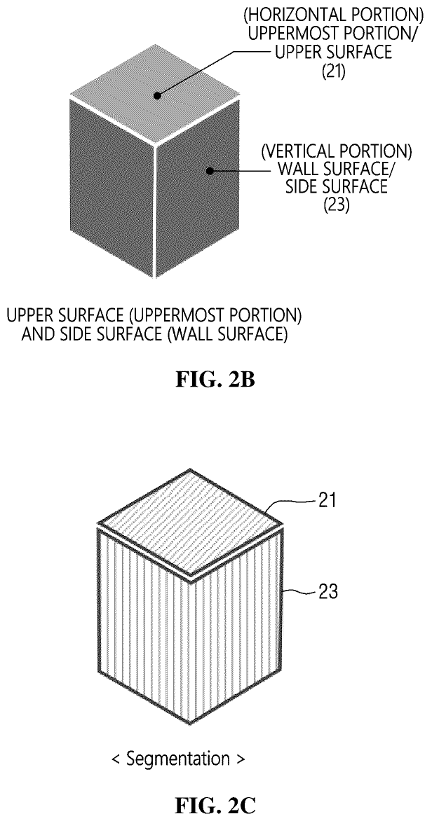

FIGS. 2A to 2C show conceptual views for describing an operation of applying a satellite image to a neural network to infer a boundary of an upper surface and a boundary of a side surface of a building included in the satellite image.

FIG. 2A illustrates a building 20 present in a satellite image. FIG. 2B is an image on which an upper surface 21 and a side surface 23 of the building 20 are displayed. FIG. 2C is an image on which boundaries of the upper surface 21 and the side surface 23 of the building 20 inferred by the neural network are displayed. In FIG. 2C, reference numeral 21 indicates the boundary of the upper surface 21 of the building 20. In FIG. 2C, reference numeral 23 indicates the boundary of the side surface 23 of the building 20. The boundary is an edge of the building 20.

In order to describe the upper surface 21 and the side surface 23 of the building 20 in FIGS. 2A to 2C, the building 20 is illustrated as having a hexahedral shape, but the building 20 may be implemented in various polyhedral shapes such as a cylindrical shape.

The building 20 is a structure built by humans and fixed to the ground. For example, the building 20 may be a building. The upper surface 21 of the building 20 is a surface positioned at an uppermost horizontal position as shown in FIG. 2B when the building 20 is considered to have a hexahedral shape. The side surface 23 of the building 20 is a surface positioned at a vertical side portion as shown in FIG. 2B when the building 20 is considered to have a hexahedral shape.

Referring to FIGS. 1 and 2, the processor 11 applies a satellite image captured by a satellite to the neural network to infer the boundary of the upper surface 21 and the boundary of the side surface 23 of the building 20 included in the satellite image. An operation of inferring the boundary of the upper surface 21 and the boundary of the side surface 23 of the building 20 included in the satellite image may be referred to as segmentation.

The processor 11 applies the satellite image to the neural network to detect the building 20 included in the satellite image and may infer the boundaries of the upper surface 21 and the side surface 23 of the detected building 20. According to embodiments, the satellite image may include two or more buildings. When two or more buildings are included in the satellite image, the processor 11 may apply the satellite image to the neural network to detect the two or more buildings included in the satellite image and may infer a boundary of an upper surface and a boundary of a side surface of each of the detected buildings.

The neural network may be a convolutional neural network (CNN) algorithm. The neural network is trained to infer the boundary of the upper surface 21 and the boundary of the side surface 23 of the building 20.

According to embodiments, by using widely known image processing algorithms, the processor 11 may detect the boundaries of the upper surface 21 and the side surface 23 of the building 20 included in the satellite image captured by the satellite. For example, the image processing algorithm may be a scale invariant feature transform (SIFT) algorithm, a speeded up robust features (SURF) algorithm, or a histogram of oriented gradients (HOG) algorithm.

The device 10 receives satellite images captured by an artificial satellite from the artificial satellite (not shown). A satellite image is a video or image captured by an artificial satellite.

According to a position and an angle of an artificial satellite, even for the same building, an appearance of the building shown on captured satellite images may vary. For example, a crude oil storage tank photographed at different positions and angles of an artificial satellite may be shown on satellite images. An appearance of the crude oil storage tank may vary on the satellite images captured at different positions and angles of the artificial satellite.

The crude oil storage tank is one embodiment of the building 20. In FIGS. 2A to 2C, the building 20 is illustrated as having as a hexahedral shape, but the crude oil storage tank may be a cylindrical shape which may be different from the hexahedral shape. A position of a side surface of the crude oil storage tank shown on the satellite images may vary due to various positions and angles of the artificial satellites.

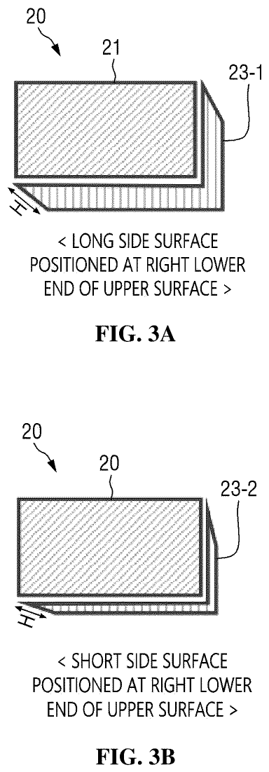

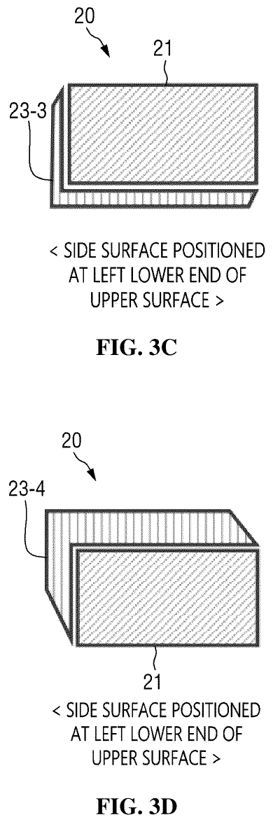

FIGS. 3A to 3D shows images for describing various position relationships between an upper surface and a side surface of a building.

Even for the same building 20, a position relationship between the upper surface 21 and the side surface 23 of the building 20 in satellite images may vary according to a position and angle of an artificial satellite. The position relationship indicates where the side surface 23 is positioned with respect to the upper surface 21 of the building 20.

FIGS. 3A to 3D are images on which a boundary of the upper surface 21 and a boundary of the side surface 23 of the building 20 inferred by the neural network are displayed. FIGS. 3A to 3D are images on which the buildings 20 are all identical to each other, but different side surfaces 23-1, 23-2, 23-3, and 23-4 of the same building 20 are shown according to a position and an angle of an artificial satellite.

In FIGS. 3A to 3D, reference numeral 21 indicates the boundary of the upper surface 21 of the building 20. In FIGS. 3A to 3D, reference numeral 23-1, 23-2, 23-3, or 23-4 indicates the boundary of the side surface 23 of the building 20.

It is assumed that the upper surfaces 21 of the building 20 in FIGS. 3A to 3D are all positioned at the same position. In this case, the side surfaces 23-1, 23-2, 23-3, and 23-4 of the building 20 may vary according to the position and angle of the artificial satellite.

FIG. 3A is an image on which a boundary of the upper surface 21 and a boundary of the side surface 23-1 of the building 20, which are inferred from a satellite image captured when the artificial satellite is at a first position and a first angle, are displayed. Referring to FIG. 3A, a long boundary of the side surface 23-1 is positioned at a right lower end of the upper surface 21 of the building 20. When the long boundary of the side surface 23-1 is positioned at the right lower end of the upper surface 21 of the building 20, the processor 11 defines a position relationship as a first position relationship.

FIG. 3B is an image on which boundaries of the upper surface 21 and the side surface 23-2 of the building 20, which are inferred from a satellite image captured when the artificial satellite is at a second position and a second angle, are displayed. Referring to FIG. 3B, a short boundary of the side surface 23-2 is positioned at a right lower end of the upper surface 21 of the building 20. A difference between long and short is determined based on an arbitrary length. For example, when a length of a thickness H of the side surface 23-1 is greater than an arbitrary length, the side surface 23-1 is determined to be long. On the other hand, when the length of the thickness H of the side surface 23-2 is less than the arbitrary length, the side surface 23-2 is determined to be short. When the short boundary of the side surface 23-2 is positioned at the right lower end of the upper surface 21 of the building 20, the processor 11 defines a position relationship as a second position relationship.

FIG. 3C is an image on which a boundary of the upper surface 21 and a boundary of the side surface 23-3 of the building 20, which are inferred from a satellite image captured when the artificial satellite is at a third position and a third angle, are displayed. Referring to FIG. 3C, a short boundary of the side surface 23-3 is positioned at a left lower end of the upper surface 21 of the building 20. When the short boundary of the side surface 23-3 is positioned at the left lower end of the upper surface 21 of the building 20, the processor 11 defines a position relationship as a third position relationship.

According to embodiments, a long boundary of a side surface (not shown) may be positioned at a left lower end of the upper surface 21 of the building 20. When the long boundary of the side surface (not shown) is positioned at the left lower end of the upper surface 21 of the building 20, the processor 11 defines a position relationship as a fourth position relationship.

FIG. 3D is an image on which boundaries of the upper surface 21 and the side surface 23-4 of the building 20, which are inferred from a satellite image captured when the artificial satellite is at a fourth position and a fourth angle, are displayed. Referring to FIG. 3D, a long boundary of the side surface 23-4 is positioned at a left upper end of the upper surface 21 of the building 20. When the long boundary of the side surface 23-4 is positioned at the left lower end of the upper surface 21 of the building 20, the processor 11 defines a position relationship as a fifth position relationship.

According to embodiments, a short boundary of a side surface (not shown) may be positioned at a left upper end of the upper surface 21 of the building 20. When the short boundary of the side surface (not shown) is positioned at the left upper end of the upper surface 21 of the building 20, the processor 11 defines a position relationship as a sixth position relationship.

In addition, according to embodiments, a short boundary of a side surface (not shown) may be positioned at a right upper end of the upper surface 21 of the building 20. When the short boundary of the side surface (not shown) is positioned at the right upper end of the upper surface 21 of the building 20, the processor 11 defines a position relationship as a seventh position relationship.

According to embodiments, a long boundary of a side surface (not shown) may be positioned at a right upper end of the upper surface 21 of the building 20. When the short boundary of the side surface (not shown) is positioned at the right upper end of the upper surface 21 of the building 20, the processor 11 defines a position relationship as an eighth position relationship.

The first to fourth positions are different positions, and the first to fourth angles are different angles.

The processor 11 generates a position relationship between the upper surface 21 and the side surface 23 of the building 20 according to the inferred boundaries of the upper surface 21 and the side surface 23 of the building 20. The processor 11 determines which of a plurality of position relationships the boundaries of the upper surface 21 and the side surface 23 of the building 20 belong to. For example, when it is assumed that long boundaries of the upper surface 21 and the side surface 23-1 of the building 20, which are inferred by the neural network, are positioned at a side of the right lower end of the upper surface 21, the processor 11 determines that the boundaries of the upper surface 21 and the side surface 23-1 of the building 20 inferred by the neural network have the first position relationship.

When a satellite image captured by the artificial satellite is applied to the neural network, boundaries of the upper surface 21 and the side surface 23 of the building included in the satellite image are inferred. That is, the boundaries are inferred as shown FIGS. 3A to 3D.

The processor 11 generates a plurality of position relationships according to boundaries of an upper surface and a side surface of a building in advance. The plurality of position relationships are the first to eight position relationships.

The processor 11 may generate a new building based on the inferred boundary of the upper surface 21 and the inferred boundary of the side surface 23 of the building 20 to synthetize the new building into the satellite image. Hereinafter, specific operations of synthesizing the new building into the satellite image will be described.

According to embodiments, the new building may be generated through a neural network based on the inferred boundary of the upper surface 21 and the inferred boundary of the side surface 23 of the building 20.

The neural network may be trained using training data such that the new building is generated based on the inferred boundary of the upper surface 21 and the inferred boundary of the side surface 23 of the building 20. The training data may be image data including the inferred boundary of the upper surface 21 and the inferred boundary of the side surface 23 of the building 20. The neural network may be a neural network algorithm based on a generative adversarial network (GAN).

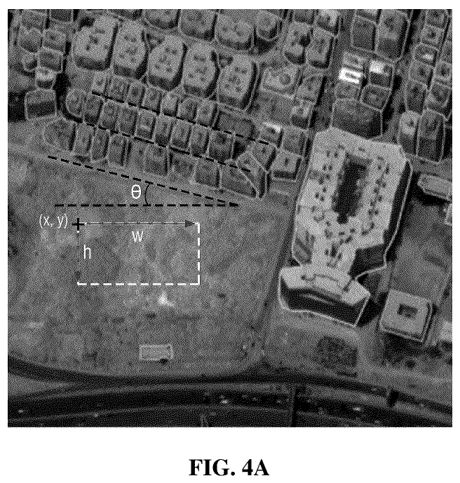

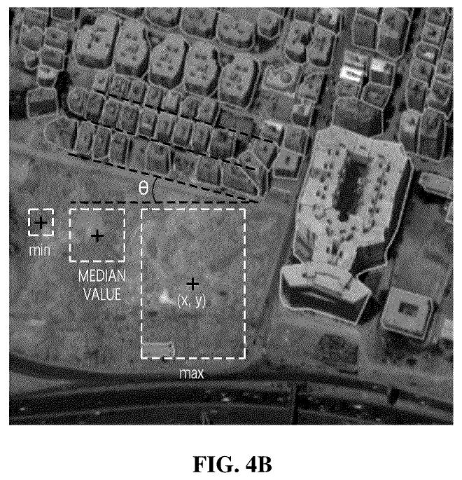

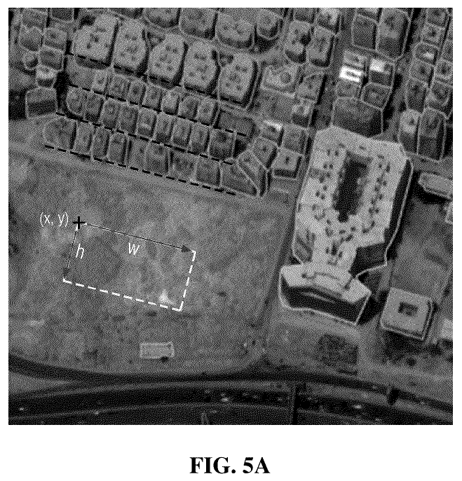

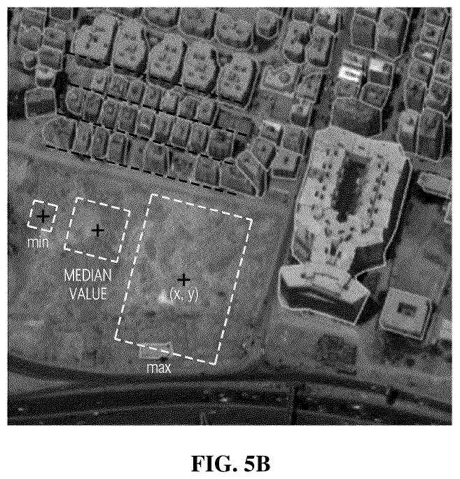

FIGS. 4A to 4B and 5A to 5B show satellite images for describing an operation of synthesizing a new building into a satellite image according to an embodiment of the present invention.

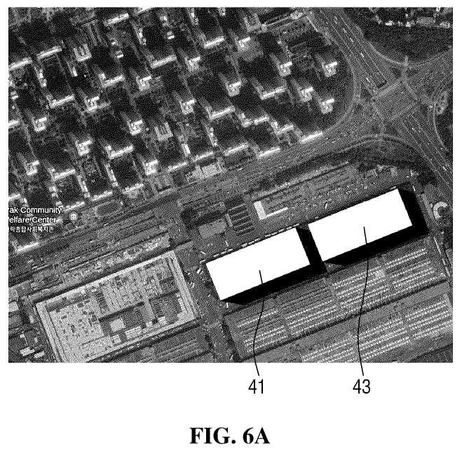

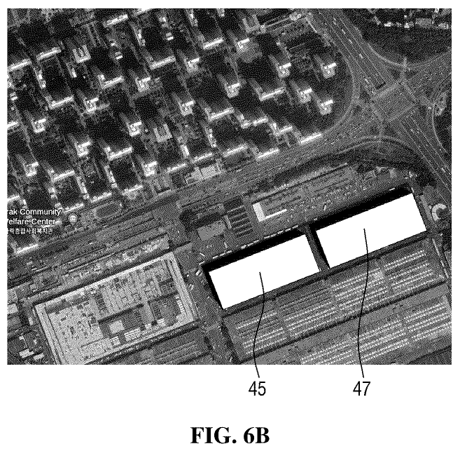

FIGS. 6A to 6B shows satellite images for describing an operation of synthesizing a new building into a satellite image.

Referring to FIGS. 1 and 4A, in order to generate the new building, the processor 11 receives information about center coordinates (x, y) of the new building, at which the new building is to be positioned in the satellite image, and information about a width w and a height h of the new building from a user. The center coordinates (x, y) of the new building and the width w and the height h of the new building are information about a position and an area of an upper surface of the new building.

The user is a user who uses the device 10. According to embodiments, the user is a user who uses an electronic device (not shown) other than the device 10. In this case, the device 10 may receive information about the center coordinates (x, y) of the new building and the information about the width w and the height h of the new building input from the other electronic device through the network.

An arbitrary point in an image shown in FIG. 4A may be an origin point (0, 0). The center coordinates (x, y) represent a point displaced from the origin point along an x-axis and a point displaced from a y-axis. The height h of the new building is a height of the upper surface of the new building occupying the satellite image. The width w of the new building is a width of the upper surface of the new building occupying the satellite image.

According to embodiment, in order to generate the new building, the processor 11 may receive information about an area of the upper surface of the new building, by which the new building is to occupy the satellite image, from a user. Hereinafter, other methods will be described.

Referring to FIGS. 1 and 4B, in order to generate the new building, the processor 11 receives information about the center coordinates (x, y) of the new building, at which the new building is to be positioned in the satellite image, and information about an area of the upper surface of the new building from a user. The area of the upper surface of the new building is an area obtained by multiplying the height h of the new building by the width w of the new building.

The processor 11 determines whether the received area of the upper surface of the new building corresponds an area between a maximum area (indicated by reference symbol “max” in FIGS. 4A to 4B) and a minimum area (indicated by reference symbol “min” in FIGS. 4A to 4B) among areas of upper surfaces of buildings included in the satellite image.

The processor 11 applies a satellite image captured by an artificial satellite to a neural network to infer boundaries of upper surfaces and side surfaces of a plurality of buildings included in the satellite image and calculate areas of the upper surfaces of the plurality of buildings. The processor 11 sorts the calculated areas of the upper surfaces of the plurality of buildings in a descending order of size and extracts a maximum area of the upper surface and a minimum area of the upper surface. FIG. 4B also shows an area of an upper surface of a building which has a median value.

When it is determined that the received area of the upper surface of the new building corresponds to an area between the maximum area and the minimum area among the areas of the upper surfaces of the buildings included in the satellite image, the processor 11 determines the received area of the upper surface of the new building.

When it is determined that the received area of the upper surface of the new building does not correspond to an area between the maximum area of the upper surface of the building and the minimum area of the upper surface of the building among the buildings included in the satellite image, the processor 11 requests the user for information about the area of the upper surface of the new building.

The request may be displayed on a display (not shown) of the device 10. In embodiments, the request may be transmitted to another device and displayed on a display of the other device. The user may re-input the area of the upper surface of the new building within a range of the maximum area of the upper surface of the building and the minimum area of the upper surface of the building according to the requested information.

Until it is determined that the received area of the upper surface of the new building corresponds to an area between the maximum area of the upper surface of the building and the minimum area of the upper surface of the building among the buildings included in the satellite image, the processor 11 requests the user for information about the area of the upper surface of the new building.

When it is determined that the received area of the upper surface of the new building corresponds to an area between the maximum area of the upper surface of the building and the minimum area of the upper surface of the building among the buildings included in the satellite image, the processor 11 determines the received area of the upper surface of the new building.

According to embodiments, the processor 11 may select an arbitrary area value between the maximum area (indicated by reference symbol “max” in FIGS. 4A to 4B) and the minimum area (indicated by reference symbol “min” in FIGS. 4A to 4B) among the areas of the upper surfaces of the buildings included in the satellite image and may set the arbitrary area value as the received area of the upper surface of the new building.

According to embodiments, the processor 11 may set an arbitrary value as the received area of the upper surface of the received new building according to a user's setting.

After determining the received area of the upper surface of the new building, the processor 11 rotates the new building synthesized into the satellite image by an inclination θ of the inferred boundary of the upper surface 21 of the building 20 according to the inclination θ of the inferred boundary of the upper surface 21 of the building 20, thereby determining a position of the upper surface of the new building.

The processor 11 first calculates the inclination θ of the inferred boundary of the upper surface 21 of the building 20. The inclination θ of the boundary of the upper surface 21 is calculated as an angle between a virtual horizontal line and the boundary of the upper surface 21.

When a plurality of buildings are included in the satellite image, the processor 11 may select a boundary of an upper surface of a building closest to the center coordinates (x, y) of the new building and may calculate an inclination between the boundary of the upper surface of the closest building and a virtual horizontal line.

The processor 11 rotates the new building synthesized into the satellite image by the inclination θ of the inferred boundary of the upper surface 21 of the building 20 according to the inclination θ of the inferred boundary of the upper surface 21 of the building 20, thereby determining the position of the upper surface of the new building.

A more natural synthetic image may be generated by rotating the new building synthesized into the satellite image by the inclination θ of the inferred boundary of the upper surface 21 of the building 20 to determine the position of the upper surface of the new building.

According to embodiments, the processor 11 may calculate inclinations of boundaries of upper surfaces of all buildings included in the satellite image. Each of the inclinations is defined as a y-axis change amount with respect to an x-axis change amount.

The processor 11 converts the x-axis change amount and a y-axis change amount into an x-axis coordinate and a y-axis coordinate for each of the inclinations. For example, when the x-axis change amount is 2 and the y-axis change amount is 4, the x-axis change amount and the y-axis change amount may be converted to coordinates (2, 4). In this case, the inclination is 2.

The processor 11 calculates principal components in a graph in which the inclinations are converted into the x-axis and y-axis coordinates, that is, two-dimensional (2D) coordinates. The principal components are principal components in principal component analysis (PCA).

The processor 11 sets the calculated principal component as a representative inclination.

The processor 11 may rotate the new building synthesized into the satellite image by the inclination of the inferred boundary of the upper surface 21 of the building 20 according to the representative inclination to determine the position of the upper surface of the new building.

FIGS. 5A to 5B show satellite images on which the new building rotated by the inclination of the inferred boundary of the upper surface of the building in the satellite image is displayed. FIG. 5A corresponds to FIG. 4A, and FIG. 5B corresponds to FIG. 4B.

After the position of the upper surface of the new building is determined, the processor 11 selects a color of the upper surface 21 of the building 20 detected in the satellite image and sets the selected color as a color of the upper surface of the new building. The area, position, and color of the upper surface of the new building may be automatically inferred through a neural network.

The processor 11 extracts the color of the upper surface of the building 20 detected in the satellite image and sets the extracted color of the upper surface as the color of the upper surface of the new building.

According to embodiments, when a plurality of buildings are included in the satellite image, the processor 11 may select a color of an upper surface of a building closest to the center coordinates (x, y) of the new building and may set the selected color as the color of the upper surface of the new building.

After the position and color of the upper surface of the new building are determined, the processor 11 determines a position of the side surface of the new building based on a position relationship defined by the inferred boundaries of the upper surface 21 and the side surface 23 of the building 20.

FIGS. 6A to 6B shows satellite images for describing an operation of synthesizing a new building into a satellite image. FIG. 6A is an undesirable synthetic image, and FIG. 6B is a desirable synthetic image.

In FIGS. 6A and 6B, it is assumed that a position and a color of an upper surface of the new building to be synthesized into the satellite image have been determined, but the color has not yet been changed.

Referring to FIG. 6A, the processor 11 generates a side surface of a new building 41 or 43 and synthetizes the side surface into the satellite image. However, a boundary of a side surface of a building inferred from a satellite image is defined as a fifth position relationship in which a long boundary of a side surface 23-4 is positioned at an inferred left upper end of the upper surface 21 of the building 20, or a sixth position relationship in which a short boundary of a side surface (not shown) is positioned at the left upper end of the upper surface 21 of the building 20. Therefore, as shown in FIG. 6A, a position of a side surface of the new building 41 or 43 does not match a position relationship of a side surface of a building already included in the satellite image, and thus the satellite image into which the new building 41 or 43 is synthesized is not natural. This is because, as shown FIG. 6A, a position relationship of the side surface of the new building 41 or 43 is defined as a first position relationship in which a long boundary of a side surface 23-1 is positioned at a right lower end of the upper surface 21 of the building 20 in FIGS. 3A to 3D, or a second position relationship in which a short boundary of a side surface 23-2 is positioned at the right lower end of the upper surface 21 of the building 20.

Referring to FIG. 6B, in order to solve an unnatural problem as shown in FIG. 6A, the processor 11 determines a position of a side surface of a new building 45 or 47 in consideration of a position relationship defined by the inferred boundaries of the upper surface 21 and the side surface 23 of the building 20. Since the position relationship defined by the inferred boundaries of the upper surface 21 and the side surface 23 of the building 20 is defined as the fifth position relationship or the sixth position relationship, the processor 11 determines the position of the side surface of the new building 45 or 47 based on the fifth position relationship or the sixth position relationship. Therefore, since the position of the side surface of the building 45 or 47 matches a position relationship of a surface of a building already included in the satellite image, a satellite image into which the new building 45 or 47 is synthesized is natural. That is, a natural synthetic image in which a new building is synthesized into a satellite image may be generated.

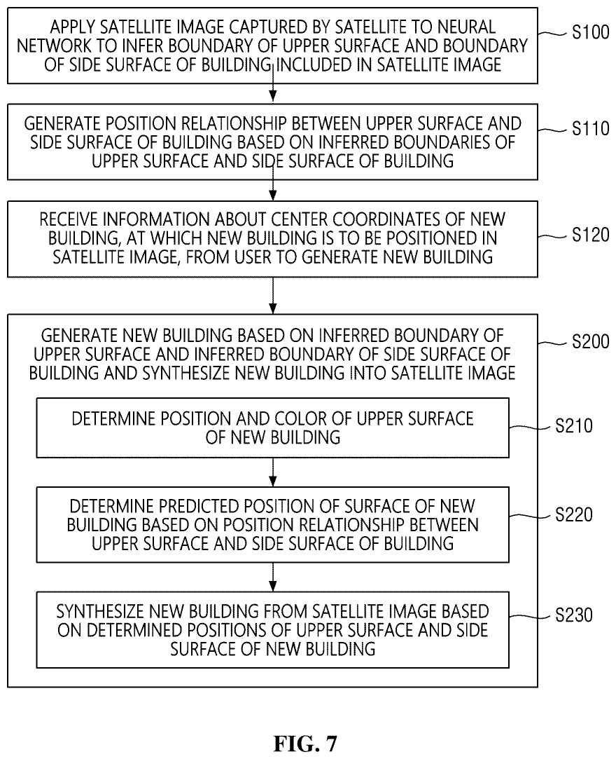

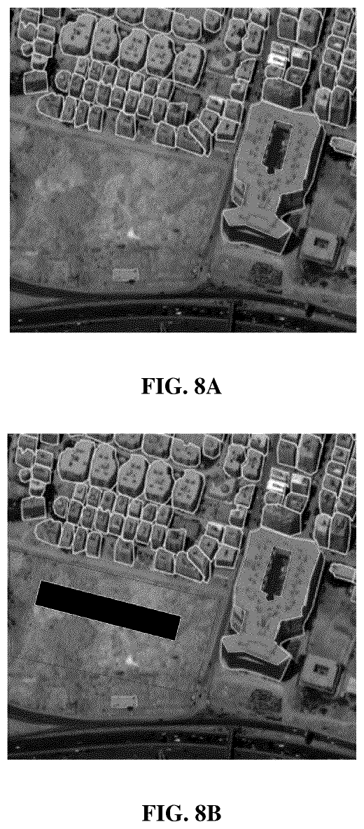

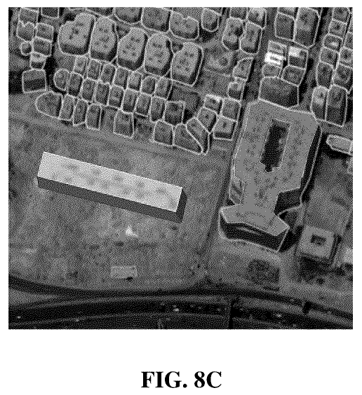

FIG. 7 is a flowchart for describing a method of generating a synthetic image based on artificial intelligence using a satellite image according to an embodiment of the present invention. FIGS. 8A to 8C shows images for describing the method of generating a synthetic image based on artificial intelligence using a satellite image according to the embodiment of the present invention.

Referring to FIGS. 1 and 8, the processor 11 applies a satellite image captured by a satellite to a neural network to infer a boundary of an upper surface 21 and a boundary of a side surface 23 of a building 20 included in the satellite image (S100). FIG. 8A is the satellite image captured by the satellite.

The processor 11 generates a position relationship between the upper surface and the side surface of the building based on the inferred boundaries of the upper surface 21 and the side surface 23 of the building 20 (S110). The processor 11 determines whether the inferred boundaries of the upper surface 21 and the side surface 23 of the building 20 correspond to one of a plurality of predetermined position relationships.

The processor 11 receives center coordinates of a new building, at which the new building is to be positioned in the satellite image, from a user to generate the new building (S120). According to embodiments, the processor 11 may further receive information about a width and a height of the new building or information about an area of an upper surface of the new building. FIG. 8B is a satellite image on which a determined upper surface of a new building is shown.

The processor 11 generates the new building based on the inferred boundary of the upper surface 21 and the inferred boundary of the side surface 23 of the building 20 and synthetizes the new building into the satellite image (S200). Hereinafter, operations of synthesizing the new building into the satellite image will be described in detail. FIG. 8C is a satellite image into which determined upper and side surfaces of the new building are synthesized.

The processor 11 determines a position and a color of the upper surface of the new building (S210). The position and color of the upper surface of the new building are automatically determined using center coordinates of the new building, an inferred area of the building 20, an inclination 0 of the boundary of the upper surface 21, and color values of an existing building. In addition, the processor 11 determines an area of the upper surface of the new building. According to embodiments, the processor 11 may determine the area of the upper surface of the new building according to a value set by a user.

The processor 11 determines a position of the surface of the new building based on an inferred position relationship between the upper surface 21 and the side surface 23 of the building 20 (S220). A detailed description thereof has been provided with reference to FIGS. 6A to 6B.

The processor 11 may determine an area of the side surface of the new building in consideration of the area of the upper surface of the new building and a ratio of an inferred area of the upper surface 21 to an inferred area of the side surface 23 of the building 20.

First, the processor 11 determines the ratio of the inferred area of the upper surface 21 to the inferred area of the side surface 23 of the building 20. For example, when the inferred area of the upper surface 21 of the building 20 is 1 and the inferred area of the side surface 23 is 0.2, the processor 11 may determine the ratio of the inferred area of the upper surface 21 to the inferred area of the side surface 23 of the building 20 to be 0.2(=0.2/1).

After determining the ratio of the inferred area of the upper surface 21 to the inferred area of the side surface 23 of the building 20, the processor 11 determines the area of the side surface of the new building based on the area of the upper surface of the new building and the determined ratio. For example, when the ratio of the inferred area of the upper surface 21 to the inferred area of the side surface 23 of the building 20 is 0.2 and the area of the upper surface of the new building is 0.5, the processor 11 may determine the area of the side surface of the new building to be 0.1.

The processor 11 synthetizes the new building from the satellite image based on the determined positions of the upper surface and the side surface of the new building (S230).

In a method and device for generating a synthetic image based on artificial intelligence using a satellite image according to an embodiment of the present invention, boundaries of an upper surface and a side surface of a building included in a satellite image are inferred to generate a new building based on the inferred boundaries of the upper surface and the side surface and synthetize the new building into the satellite image, thereby obtaining an effect generating a natural synthetic image.

The present invention has been described with reference to embodiments shown in the drawings, but this is merely illustrative, and those skilled in the art will understand that various modifications and other equivalent embodiments are possible therefrom. Therefore, the true scope of technical protection of the present invention should be determined by the technical spirit of the attached registration claims.

What is claimed is:

1. A method of generating a synthetic image based on artificial intelligence using a satellite image, which is performed by a processor, the method comprising:
applying a satellite image captured by a satellite to a neural network to infer a boundary of an upper surface and a boundary of a side surface of a building included in the satellite image; and
generating a new building based on the inferred boundary of the upper surface and the inferred boundary of the side surface of the building and synthesizing the new building into the satellite image.

2. The method of claim 1, further comprising generating an inferred position relationship between the upper surface and the side surface of the building based on the inferred boundary of the upper surface and the inferred boundary of the side surface of the building.

3. The method of claim 1, further comprising receiving information about center coordinates of the new building, at which the new building is to be positioned in the satellite image, and information about a width and a height of the new building from a user to generate the new building.

4. The method of claim 1, further comprising:
receiving information about center coordinates of the new building, at which the new building is to be positioned in the satellite image, and information about an area of an upper surface of the new building from a user to generate the new building;
determining whether the received area of the upper surface of the new building corresponds to an area between a maximum and a minimum area among areas of upper surfaces of buildings included in the satellite image; and
requesting the user for information about the area of the upper surface of the new building when it is determined that the received area of the upper surface of the new building does not correspond to the area between the maximum area and the minimum area among the areas of the upper surfaces of the buildings included in the satellite image.

5. The method of claim 1, further comprising rotating the new building synthesized into the satellite image according to an inclination of the inferred boundary of the upper surface of the building.

6. A device comprising:
a processor configured to execute instructions for generating a synthetic image based on artificial intelligence using a satellite image; and
a memory configured to store the instructions,
wherein the instructions are implemented to apply a satellite image captured by a satellite to a neural network to infer a boundary of an upper surface and a boundary of a side surface of a building included in the satellite image, and generate a new building based on the inferred boundary of the upper surface and the inferred boundary of the side surface of the building to synthetize the new building into the satellite image.

7. The device of claim 6, wherein the instructions are further implemented to generate an inferred position relationship between the upper surface and the side surface of the building based on the inferred boundary of the upper surface and the inferred boundary of the side surface of the building.

8. The device of claim 6, wherein the instructions are further implemented to receive center coordinates of the new building, at which the new building is to be positioned in the satellite image, and information about a width and a height of the new building from a user to generate the new building.

9. The device of claim 6, wherein the instructions are further implemented to receive information center coordinates of the new building, at which the new building is to be positioned in the satellite image, and information about an area of an upper surface of the new building from a user to generate the new building, determine whether the received area of the upper surface of the new building corresponds to an area between a maximum and a minimum area among areas of upper surfaces of buildings included in the satellite image, and request the user for information about the area of the upper surface of the new building when it is determined that the received area of the upper surface of the new building does not correspond to the area between the maximum area and the minimum area among the areas of the upper surfaces of the buildings included in the satellite image.

10. The device of claim 6, wherein the instructions are further implemented to rotate the new building synthesized into the satellite image according to an inclination of the inferred boundary of the upper surface of the building.
